(19) United States
(12) Patent Application Publication
(10) Pub. No.: US 2009/0266105 A1
(43) Pub. Date: Oct. 29, 2009

(54) HEAT EXCHANGER

(75) Inventors: Bengt Ake Viklund, Grasturp (SE); Gote Gunnar Berggren, Lidkuping (SE); Niels Liengard, Ry (DK)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6731, US

(73) Assignee: BUNDY REFRIGERATION INTERNATIONAL HOLDINGS B.V., NJ Rotterdam (NL)

(21) Appl. No.: 11/722,067

(22) PCT Filed: Dec. 13, 2005
(86) PCT No.: PCT/GB05/04771

§ 371 Date: Sep. 26, 2007

(30) Foreign Application Priority Data
Dec. 22, 2004 (GB) 0428029.3

(51) Int. Cl. F28F 1/12; F25B 39/04; B23P 15/26

(52) U.S. Cl. 62/498; 165/168; 29/890.038

(57) ABSTRACT

A heat exchanger (102) for use in a refrigeration unit (101), comprising a metal plate (201) and a metal tube (202) for containing refrigerant (203). The metal plate (201) has a first face (204) and a second face (205), and the tube (202) is attached to said first face (204) of the metal plate by a plurality of spot welds (405,406). The spot welds are laser spot welds and said welds extend through only a portion of the thickness of the plate (201), such that the second face (205) of the plate is undisturbed by the welds.

### BACKGROUND OF THE INVENTION

The present invention relates to a heat exchanger for use in a refrigeration unit, a method of manufacturing a heat exchanger for a refrigeration unit, and a refrigeration unit comprising a heat exchanger.

It is well known for refrigeration units, such as domestic refrigerators, to have heat exchangers which comprise of a metal tube which carries a refrigerant. The heat exchanger could typically be an evaporator within which refrigerant evaporates and thereby absorbs latent heat of evaporation, or it could be a condenser within which the refrigerant re-condenses back into liquid form. It is also known for the tube of the heat exchanger to be attached to a metal plate. In instances where the heat exchanger is used as an evaporator, the metal plate is used to conduct heat from a refrigeration cavity, where items are stored, to the tube containing the refrigerant. It is also known to attach the metal tube to the plate by brazing.

A problem with such a brazed evaporator is that it is relatively costly to make due to the materials required and the number and duration of the manufacturing processes involved.

### BRIEF SUMMARY OF THE INVENTION

According to a first aspect of the present invention, there is provided a heat exchanger for use in a refrigeration unit, said heat exchanger comprising: a metal plate having a first face and a second face; and a metal tube for containing refrigerant attached to said first face of said metal plate by a plurality of spot welds, wherein said spot welds are laser spot welds and said welds extend through only a portion of the thickness of said plate.

According to a second aspect of the present invention, there is provided a method of manufacturing a heat exchanger for a refrigeration unit, comprising the steps of: obtaining a metal plate having a first face and a second face; and attaching a metal tube for containing refrigerant to said first face of said metal plate by a plurality of spot welds, wherein said spot welds are made by a laser and said welds extend through only a portion of the thickness of said plate.

According to a third aspect of the present invention there is provided a refrigeration unit having a heat exchanger, said heat exchanger comprising: a metal plate having a first face and a second face; and a metal tube for containing refrigerant attached to said first face of said metal plate by a plurality of laser spot welds.

### BRIEF DESCRIPTION OF THE SEVERAL VIEWS OF THE DRAWINGS

FIG. 1 shows a refrigeration unit 101 incorporating a refrigeration evaporator 102;

FIG. 2 shows a simplified cross-section of the evaporator 102 mounted within refrigeration unit 101;

FIG. 3 shows a simplified cross-sectional view of an alternative refrigeration unit 301;

FIG. 4 shows a plan view of the evaporator 102;

FIG. 5 shows a perspective view of the evaporator 102;

FIG. 6 shows a flow chart illustrating a method for manufacturing the evaporator 102;

FIG. 7 shows schematically apparatus for welding the tube to the plate at step 606 of FIG. 6;

FIG. 8 shows positioning apparatus 106 and laser focus heads 105A and 105B laser spot welding a tube 202 on a plate 201;

FIG. 9 shows positioning rollers that are located within the positioning head 804 of FIG. 8;

FIG. 10 shows a portion of the tube 202 and plate 201 and illustrates the position of welds 1001;

FIG. 11 shows a cross-section of a portion of the evaporator 102 after application of the protective layer 1101;

FIG. 12 shows an alternative evaporator 1202 to the evaporator 102;

FIG. 13 shows a further alternative evaporator 1302; and

FIG. 14 shows a further alternative evaporator 1402.

### WRITTEN DESCRIPTION OF THE BEST MODE FOR CARRYING OUT THE INVENTION

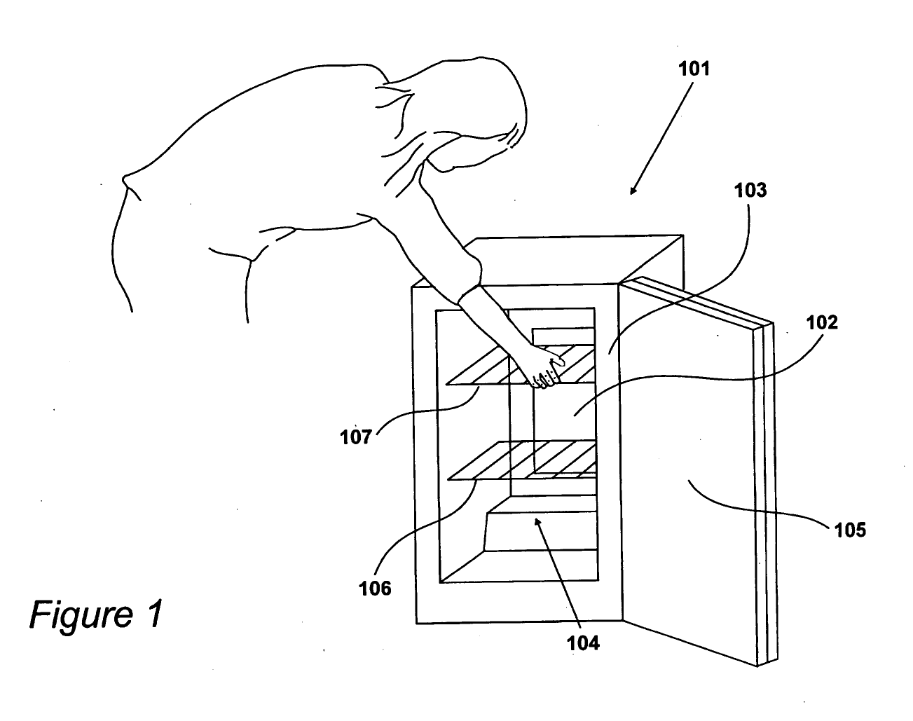

FIG. 1

FIG. 1 illustrates a refrigeration unit 101 incorporating a refrigeration evaporator 102. Refrigeration evaporator 102 is mounted to the rear wall of inner refrigeration cavity walling 103 within the refrigeration cavity 104, so that one side of the refrigeration evaporator 102 is visible within refrigeration cavity 104, when refrigeration unit door 105 is open. Refrigeration cavity 104 is typically used to temporarily store and preserve perishable items, for example, consumable food goods. The evaporator 102 has the appearance of a plane sheet of material with a smooth unmarked surface.

Refrigeration unit 101 is fitted with removable shelves 106 and 107 within the refrigeration cavity 104 to maximise the available storage space.

In the present embodiment, the refrigeration unit is a domestic refrigerator. However, in alternative embodiments, the refrigeration unit is a refrigerator used commercially for storing and displaying items for sale, for example in a shop. In other alternative embodiments, the refrigeration unit is a freezer.

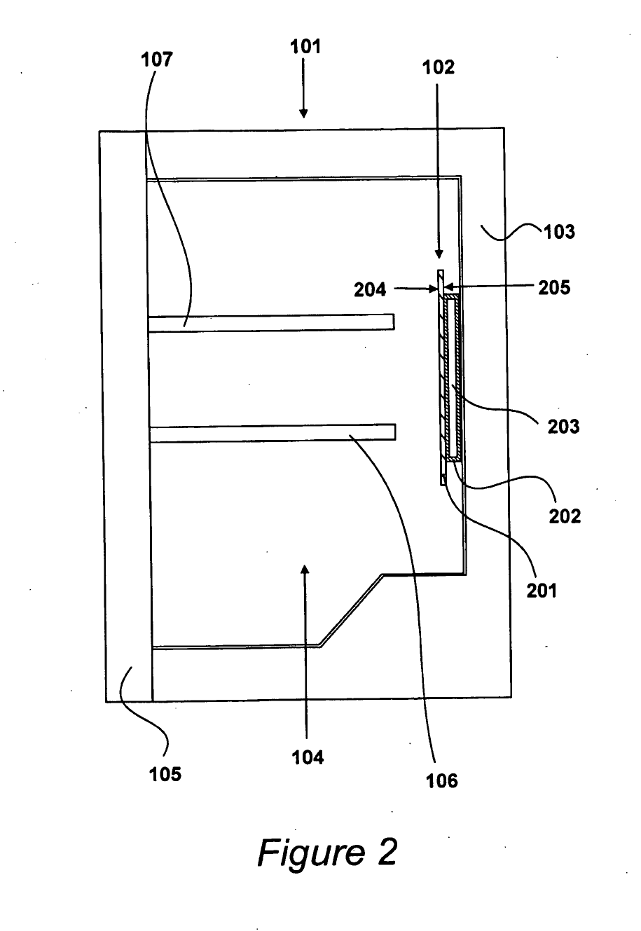

FIG. 2

A simplified cross-section of the evaporator 102 mounted within refrigeration unit 101 is shown in FIG. 2. The evaporator 102 is mounted against the rear wall of inner refrigeration cavity walling 103 within the refrigeration cavity 104 such that the evaporator 102 is visible when the refrigeration unit door 105 is open. The evaporator 102 comprises a metal plate 201 which has a front face 204 that is visible to users of the refrigeration unit 101. The metal plate also has a rear surface 205 that is welded to a tube 202 through which passes a refrigerant fluid 203. Due to the manner by which the tube 202 is welded to the plate 201, the front face of the plate 201 is unmarked and flat.

During use, heat from the refrigeration cavity 104 is absorbed by the plate 201. The heat is conducted through the plate to the tube 202, and through the wall of the tube to the refrigerant fluid 203 causing it to evaporate. Thus, the evaporator is used to transport heat away from the cavity 104. Because the evaporator is located within the refrigeration cavity 104, and in direct contact with the air within said cavity, the efficiency of refrigeration unit 101 is enhanced.

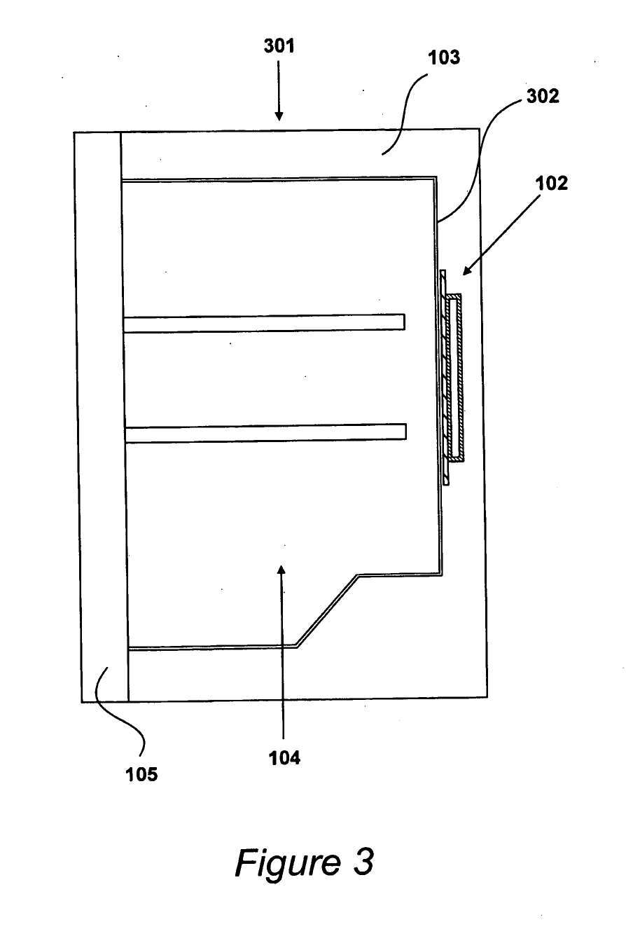

FIG. 3

An alternative refrigeration unit 301 is shown in a simplified cross-sectional view in FIG. 3. The refrigeration unit 301 differs from refrigeration unit 101 in that the evaporator 102 of refrigeration unit 301 is located within the rear wall of the inner refrigerator cavity walling. Consequently, it is concealed from users of the unit 301, even when the door 105 of said unit is open.

The arrangement of FIG. 3 is less efficient than that of FIGS. 1 and 2, because heat must pass through a first layer 302 of the inner cavity walling before being absorbed by the evaporator 102. However, it is to be noted that the same type of evaporator 102 is useable in either location.

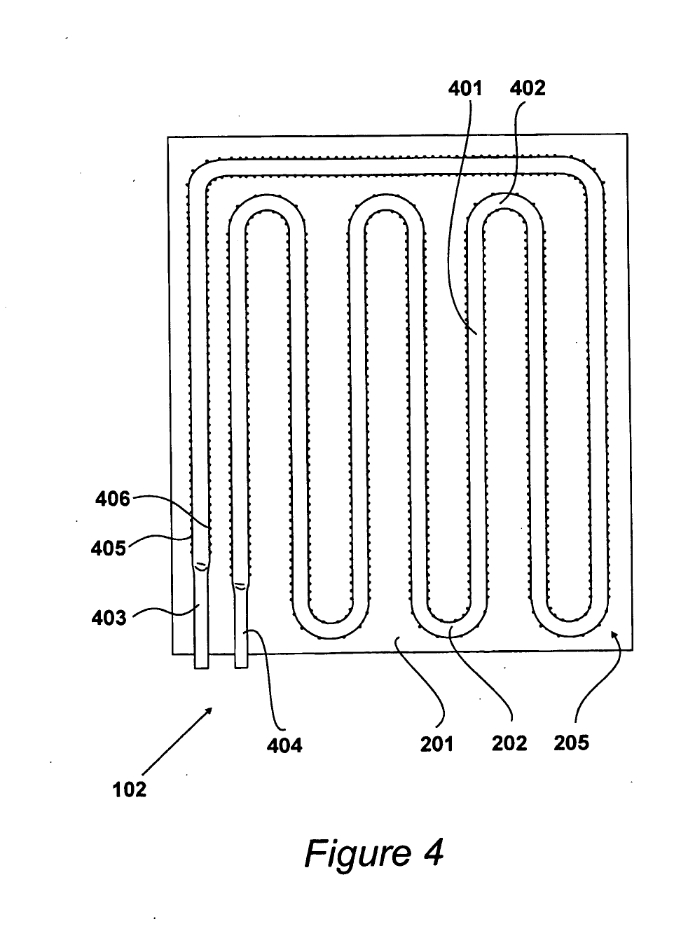

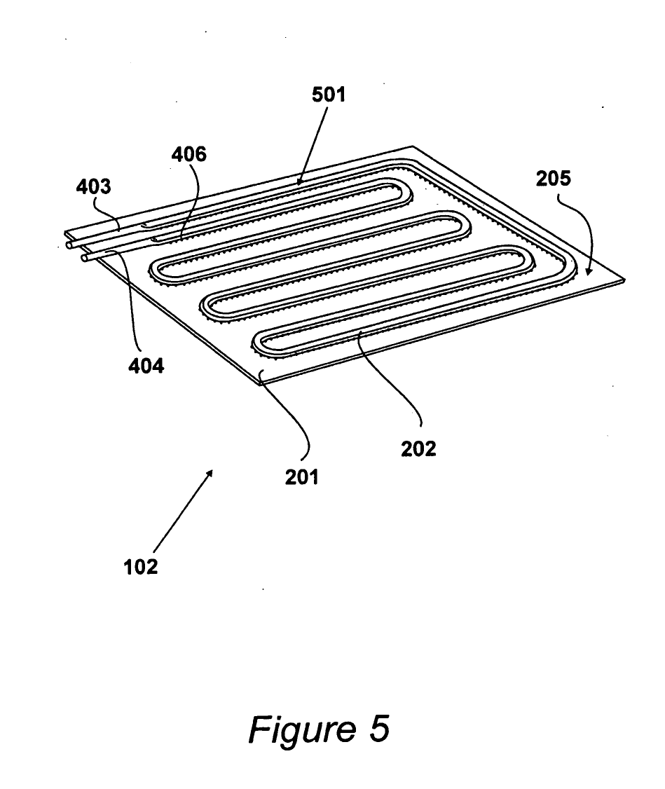

FIGS. 4 and 5

The evaporator 102 is shown in detail in the plan view of FIG. 4 and the perspective view of FIG. 5.

The tube 202 has a meandering shape providing good coverage of the plate 201, in that all locations on the plate 201 are within a predetermined distance from the tube 202. In the present embodiment, the tube 202 has a serpentine shape having several substantially straight portions, such as portion 401, connected by 180 degree bends, such as bend 402. However, meandering shapes other than serpentine are envisaged which provide the required coverage of the plate.

A middle portion of the tube 202 has a flat face which is located against the rear face 205 of the plate 201, and a second flat face 501 parallel to the first face. Two smaller portions 403 and 404 at each end of the tube 202 have a circular cross-section allowing them to be easily connected to other circular cross-section tubes within the cooling circuit of the refrigeration unit 101.

The tube 202 is rigidly attached to the plate 201 by laser spot welds, such as welds 405 and 406, which weld the metal of the tube directly to the metal of the plate. In the present embodiment, the laser spot welds are spaced along the tube 202, both along the straight portions, such as portion 401, and along the bends, such as bend 402. The distance between the spot welds along the straight portions is 5 millimetres but this distance is extended to up to 25 millimetres in some alternative embodiments and reduced to less than 5 millimetres in others. It will be understood that the increased number of welds ensures the integrity of the plate/tube unit, although it does also increase the production time and cost. However, if the spot welds are arranged too closely and are performed too rapidly, then over heating of the plate can produce undesirable distortions of the plate that would be detrimental to its appearance.

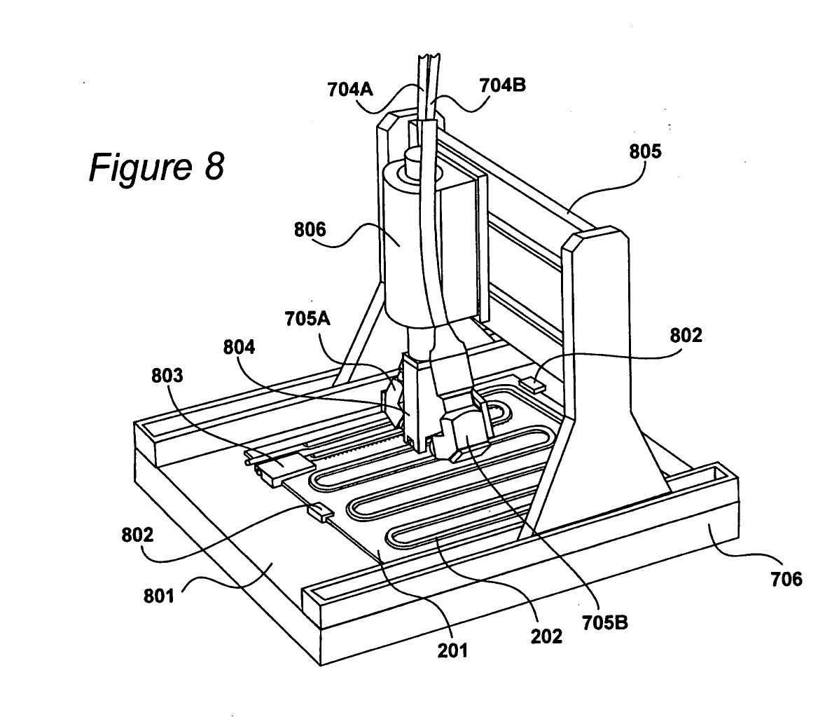

The cross-sectional shape of the tube within its central portion and the position of the spot welds is described below in further detail with respect of FIGS. 8, 9 and 10.

The plate 201 and the tube 202 are made from aluminium alloy, or alternatively aluminium. These materials have good thermal conductivity and therefore provide the evaporator with high efficiency. In addition, they facilitate successful, reproducible, laser welding, and have good resistance to corrosion during use.

The plate 201 of the present embodiment has a thickness of 1.5 millimetres but thinner plates down to around 0.5 millimetre may be used in order to reduce the material cost. It will be understood that reducing the plate gauge reduces the thermal conductivity of the plate along the plane. To compensate for this, the tube coverage of the plate may be increased. However, the additional tube length required to increase tube coverage of the plate will increase its cost. In practice, therefore, the actual plate thickness and tube coverage that is used may depend upon a number of variants including plate and tube material costs, efficiency requirements, evaporator dimensions, etc.

The tube 202 has a wall thickness of approximately 0.5 millimetres. Tubes with a larger wall thickness may be used but this will increase the cost of the tube.

In one alternative, low cost, embodiment the tube is made from aluminium coated steel tube. Other types of metal tube and metal plates may also be used provided they permit laser welding, and they have the required thermal conductivity and resistance to corrosion.

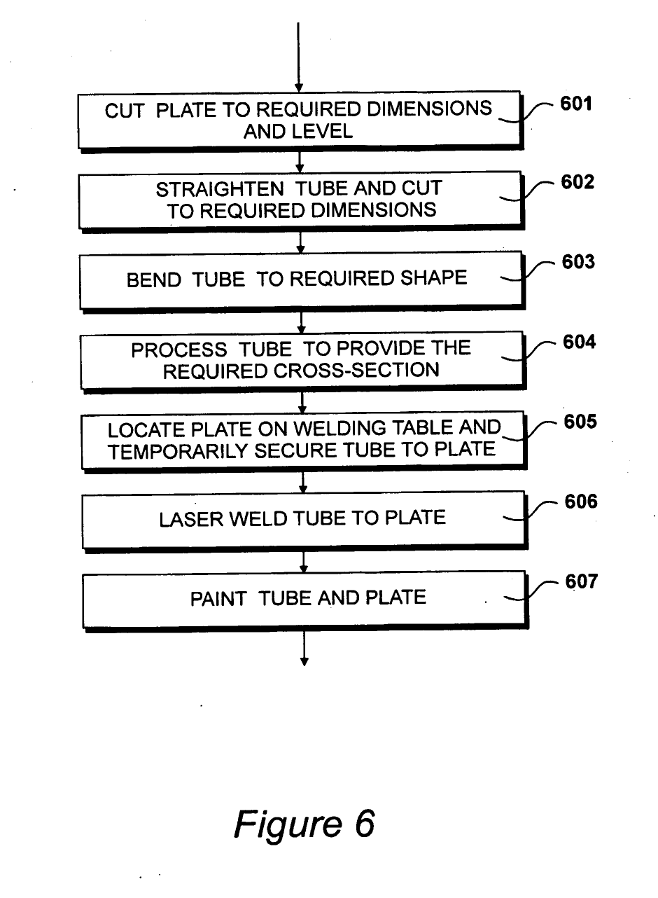

FIG. 6

A method for manufacturing the evaporator 102 is illustrated by the flow chart of FIG. 6. Initially at step 601 aluminium alloy sheet is cut to desired dimensions using a guillotine and then levelled. At step 602, aluminium tube having a circular cross-section is straightened and cut to the required length. The tube is then bent to the required shape at step 603. For example, the tube is bent to form the serpentine shape shown in FIG. 4. The bent tube obtained at step 603 is then processed by a press, for example a hydraulic press, at step 604 to provide the required cross-section of its central portion. Thus, at step 604 the tube is deformed such that it is provided with a pair of substantially parallel flat faces over a central portion while leaving the end portions 403 and 404 cylindrical.

The plate produced by step 601 is then secured to a welding table at step 605, and the tube produced at step 604 is temporarily secured to the plate in the required position, ready for welding. At step 606 the tube is laser spot welded to the plate.

Finally at step 607 the tube and plate are painted in order to resist moisture or ice entering any space left between the tube and the plate. Before the painting takes place the tube and plate are cleaned and degreased to ensure adhesion of the paint.

In an alternative embodiment, the aluminium alloy sheet used at step 601 is pre-coated on one side with a polymer layer, such as a layer of polyester. The tube is then located and welded on the non-coated side of the plate at steps 605 and 606. In this embodiment, it is envisaged that the painting step 607 will be omitted, and consequently degreasing is also not required.

In further alternative embodiments, extruded tubing having at least one flat side is used at step 602 in place of cylindrical tubing. Consequently, the step 604 of processing the tube to provide the required cross-section is omitted, and the tube is bent at step 603 such that the flat side produced by extrusion remains planar. The flat side produced during the extrusion of the tube is then located and welded against the plate at steps 605 and 606. For example, in one embodiment, the tube is extruded such that it has a rectangular cross-section, while in another embodiment the tube is extruded such that it has two flat parallel planes and curved side walls. Thus, in the latter case the tube has a cross-section similar to that of the cylindrical tube after process step 604.

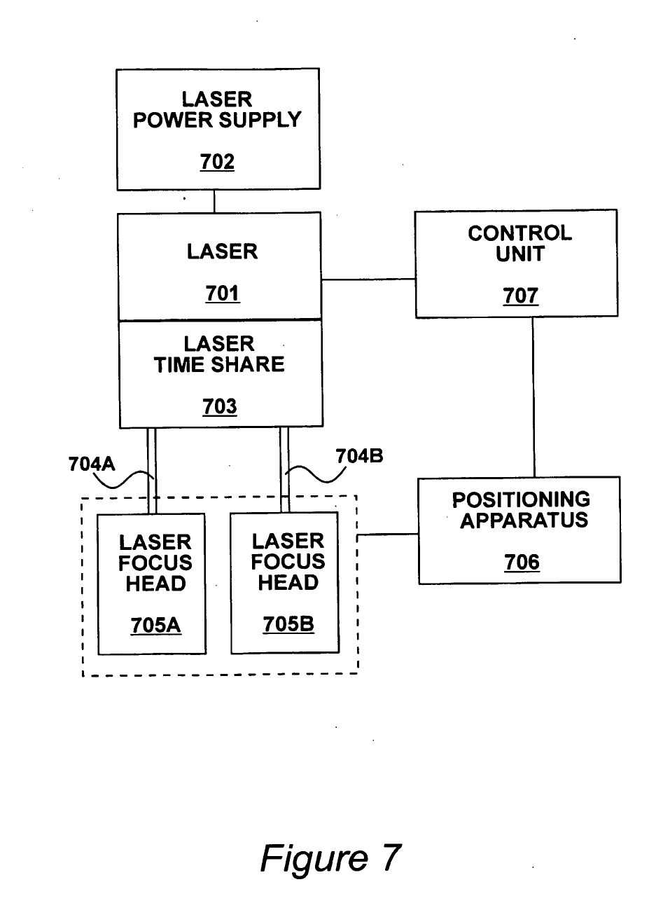

FIG. 7

Apparatus for welding the tube to the plate at step 606 of FIG. 6 is shown schematically in FIG. 7. The apparatus includes a laser 701 suitable for producing pulses of laser light to produce the spot welds between the tube 202 and the plate 201, and a suitable power supply 702 for the laser 701. The laser 701 has an associated time share device 703 which receives the laser beam from the laser and switches it between two output ports. In the present embodiment the laser 701 is a JK700 series laser produced by GSI Lumonics, UK, which is supplied with suitable power supply 702 and time share device 703.

A fibre optic link 704A, 704B is connected between each of the output ports of the time share device 703 and a respective laser focus head 705A, 705B. The fibre optic links 704A and 704B are configured to receive the laser beam from the laser time share device 703 and deliver it to the laser focus heads 705A and 705B. The laser focus heads are configured to receive the laser beam from the respective fibre optic link and focus it on the work piece to produce a spot weld. The fibre optic links and laser focus head may also be obtained from GSI Lumonics.

In order to apply the laser beam at the required positions of welds, the apparatus also includes a positioning apparatus 706 which controls the positioning of the laser focus heads 705A and 705B with respect to the tube 202 and plate 201. A control unit 707 in the form of a programmed computer controls the positioning apparatus 706 and laser 701 in order to co-ordinate the positioning of the laser focus heads 705A, 705B and welding of the evaporator 102.

In alternative apparatus to that of FIG. 7, the time share device is replaced by a beam splitting device which shares the energy of the laser beam thereby instantaneously providing a laser beam to each of the fibre optic links.

FIG. 8

Positioning apparatus 706 and laser focus heads 705A and 705B are shown laser spot welding a tube 202 on a plate 201 in FIG. 8. The plate 201 is rigidly fixed to a table 801 by clamps 802, while a clamp 803 holds one end of the tube 202 in position on the plate 201.

The laser focus heads 705A and 705B are fixed to a positioning head 804 whose linear position is adjustable by a moveable gantry 805 and angular position is adjustable by a rotation positioning device 806. The positioning head 804 includes rollers which apply forces to position the tube 202 at a location adjacent to where the laser beams are currently focused.

During operation, under the control of the control unit 707, the laser beam focussing heads are initially positioned adjacent to the clamped end of the tube 202 and then they are moved along the tube on a path defined by its intended position and shape. As the focus heads 705A and 705B are moved, the rollers in the positioning head 804 ensure the correct positioning of the tube 202. Meanwhile, under the control of unit 707, the laser periodically produces a laser beam to produce a weld. The time share device 703 deflects the laser beam first to one focus head and then the other and consequently spot welds are produced along each side of the tube.

The laser welds disturb only the rear surface of the plate leaving the front surface, that is viewable by a user of the refrigeration unit 101, unmarked by the welding process.

In the present embodiment, the tube 202 and plate 201 remain stationary while the laser focus heads 705A and 705B are moved into position by the positioning apparatus for welding. However, in an alternative embodiment the tube and plate assembly is fixed to a X-Y positioning table which moves the tube and plate in a horizontal plane and with respect to the laser focus heads. Thus, in the main embodiment and this alternative embodiment, the positioning apparatus positions the laser focus heads with respect to the tube and plate, but this may be achieved by moving the laser focus heads and/or the tube and plate assembly.

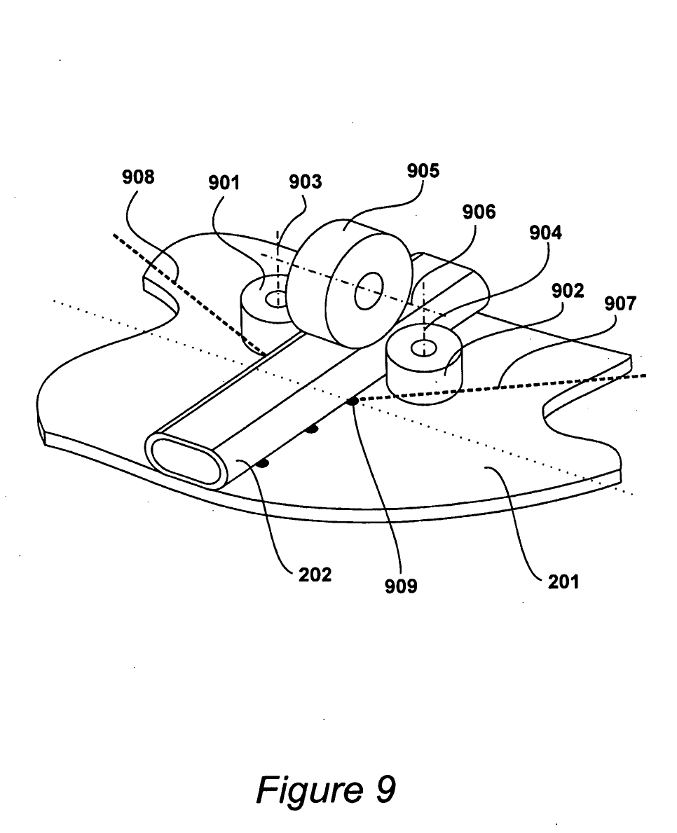

FIG. 9

Positioning rollers that are located within the positioning head 804 are shown in FIG. 9. The positioning head 804 includes a pair of rollers 901 and 902 that are mounted at a fixed position with respect to the focus heads but they are able to rotate around vertical axes 903 and 904. The gap between the two rollers 901 and 902 is sufficient to allow the tube 202 to fit between them.

A third roller 905 is mounted such that it is able to rotate about a horizontal axis 906 parallel to the plane of the axes 903 and 904.

During operation, the roller 905 applies downward force to the tube 202 to ensure it is pressed up against the plate 201. The rollers 901 and 902 apply sideways forces to the tube to ensure its correct positioning before laser beams 907 and 908 produce spot welds 909. As shown in FIG. 9, the three rollers 901, 902 and 905 are positioned such that the laser beams 907 and 908 produce new welds between the previous welds and the rollers. I.e. the rollers move along the tube in advance of the laser beam.

The laser focus heads 705A and 705B are arranged such that the laser beams 907 and 908 are oriented at an angle of between 15 and 20 degrees to the plane of the plate 201.

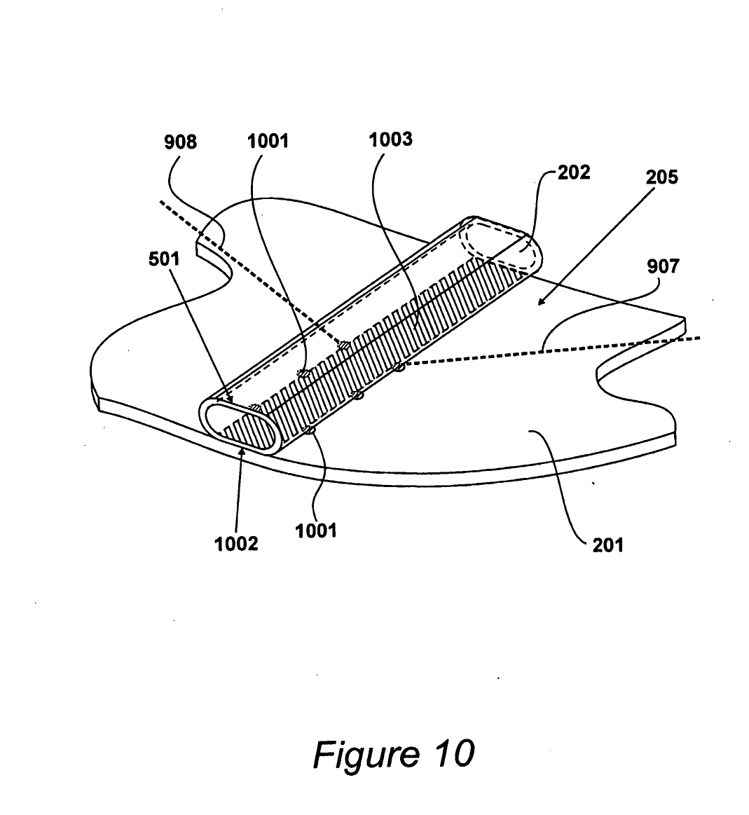

FIG. 10

A portion of the tube 202 and plate 201 are shown in FIG. 10 which illustrates the position of welds 1001. As described above, the tube 202 is produced by applying pressure to a cylindrical tube to. create a pair of parallel faces, and therefore the tube 202 has a first flat face 1002 and a second flat face 501 parallel to the first face.

The first face 1002 of the tube is located against the rear face 205 of the plate 201 and therefore a tube to plate interface 1003 (shown hatched) is produced. Spot welds 1001 are then produced along the tube 202 on each side of the interface 1003 by laser beams 907 and 908.

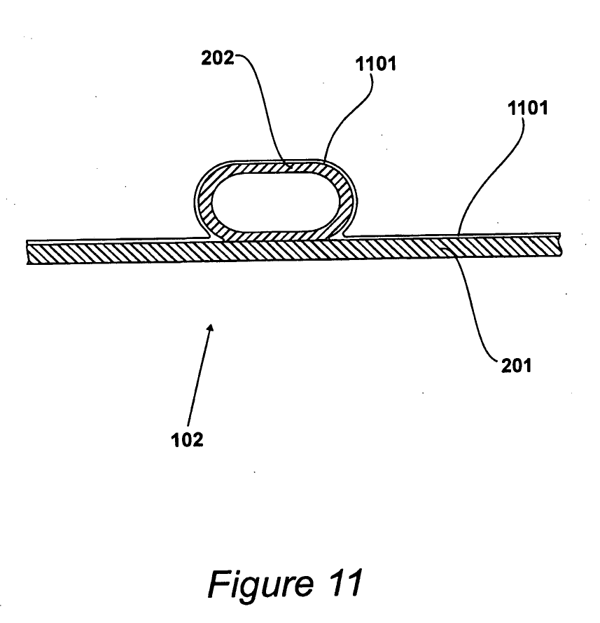

FIG. 11

A cross-section of a portion of the evaporator 102 is shown in FIG. 11, after application of the protective layer 1101 at step 607.

It is possible that a gap or gaps could exist between the tube 202 and the plate 201. If water entered such a gap and solidified it could potentially affect the configuration of the tube to plate interface and reduce the thermal conductivity between tube and plate.

The protective layer 1101 extends over the plate 201 and the tube 202 such that the tube to plate interface 1003 is sealed from the atmosphere. Consequently, if any gap does exist between the tube and the plate, the layer 1101 provides a barrier against water entering said gap.

In the present embodiment the layer 1101 is a layer of paint, applied by spraying on powder paint, but other methods of application such as dipping are envisaged.

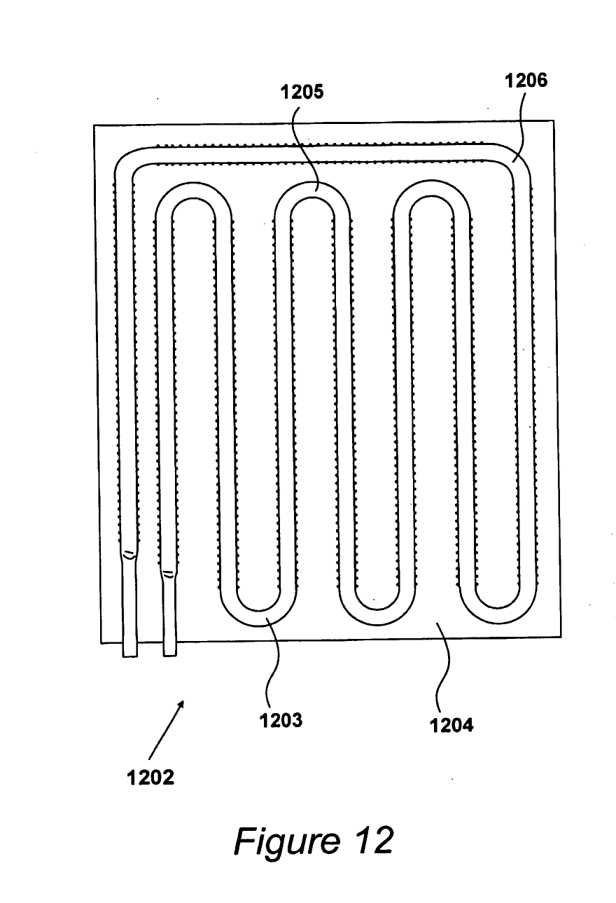

FIG. 12

An alternative evaporator 1202 to the evaporator 102 is shown in FIG. 12. The evaporator 1202 is manufactured in a similar way to evaporator 102 and has the same type of tube 1203 laser spot welded to a plate 1204 as those of evaporator 102. However, the laser welds only extend along the straight portions of the tube 1203 and not around the bends, such as bends 1205 and 1206. Consequently, the welding apparatus may be simplified.

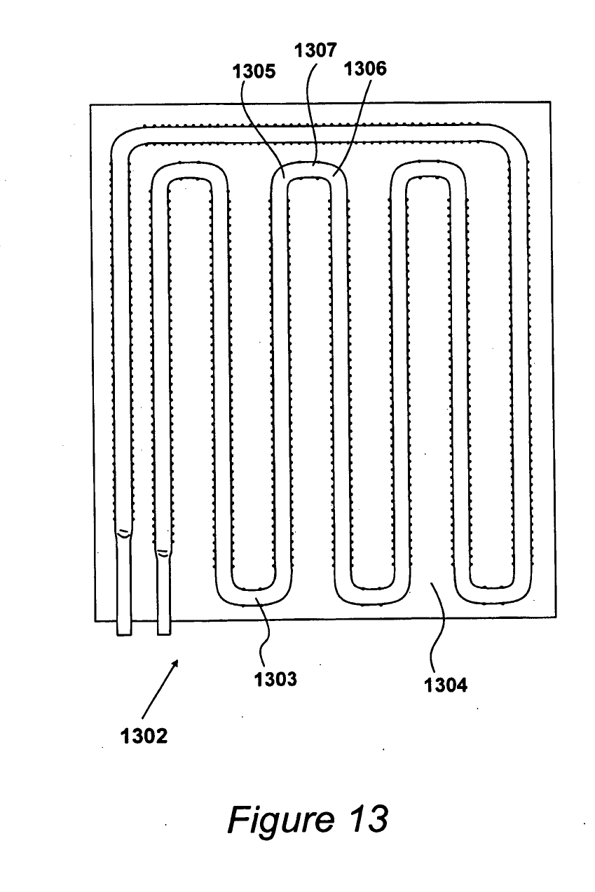

FIG. 13

A further alternative evaporator 1302 is shown in FIG. 13. Like evaporator 1202, the tube 1303 is only welded to the plate 1304 along straight portions of the tube. However, the tube has been bent at step 603 in such a way that the 180 degree bends have been replaced by two 90 degree bends of smaller radius of curvature, such as bends 1305 and 1306, separated by a substantially straight portion, such a portion 1307.

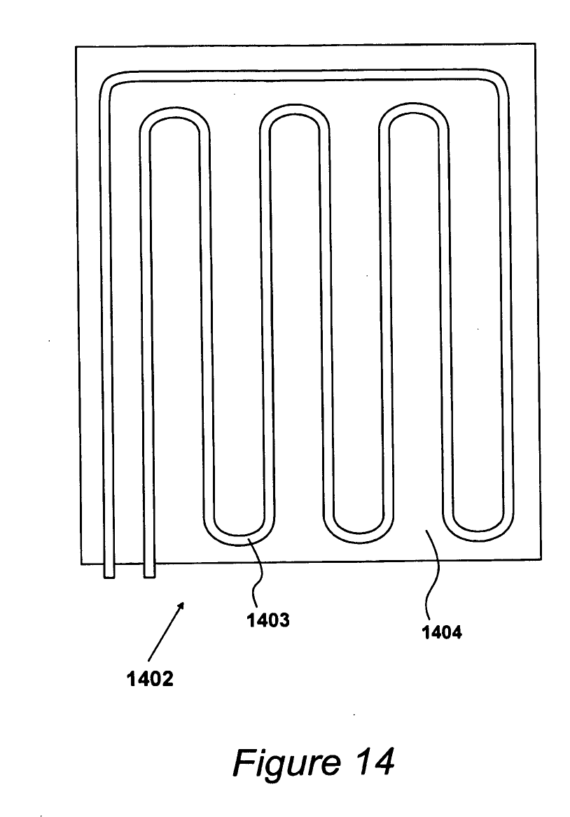

FIG. 14

A further alternative evaporator 1402 is shown in FIG. 14. This evaporator differs from evaporator 102 in that its tube was not processed at step 604, and consequently it comprises a tube 1403 with a circular cross-section that is laser welded to a plate 1404.

In the present embodiment, the tube 1403 is laser spot welded to the plate 1404 in the same manner as described for evaporator 102. However, due to the very narrow width of the interface between the tube 1403 and plate 1404, it is envisaged that welding may only be performed along one side of the interface.

In each of the above described embodiments, the heat exchanger takes the form of an evaporator for use within a refrigeration unit such as a refrigerator or freezer. However, in alternative embodiments, heat exchangers manufactured in a similar way to the above described evaporators are used as condensers that are mounted on the outside of a refrigeration unit.

1. A heat exchanger for use in a refrigeration unit, said heat exchanger comprising: a metal plate having a first face and a second face; and
a metal tube for containing refrigerant attached to said first face of said metal plate by a plurality of spot welds,
wherein said spot welds are laser spot welds and said welds extend through only a portion of the thickness of said plate.

2. A heat exchanger according to claim 1, wherein at least a portion of the length of said tube has a substantially flat face positioned against said first face of said plate.

3. A heat exchanger according to claim 2, wherein said tube has a second substantially flat face parallel to the substantially flat face positioned against the plate.

4. A heat exchanger according to claim 2, wherein said tube has portions adjacent to each of its ends which have a circular cross-section for connecting to other tubes in the refrigeration unit.

5. A heat exchanger according to claim 1, wherein said tube has a circular cross-section.

6. A heat exchanger according to claim 1, wherein said tube and said plate comprise of aluminium or aluminium alloy.

7. A heat exchanger according to claim 1, wherein said tube is positioned against said plate to provide a tube/plate interface and said spot welds are spaced along said tube on either side of said interface.

8. A heat exchanger according to claim 1, wherein at least a portion of the length of said tube has a substantially flat face positioned against said first face of said plate to provide a tube/plate interface and said spot welds are spaced along said tube on either side of said interface.

9. A heat exchanger according to claim 1, wherein said heat exchanger has a protective layer extending over said first face of said plate and a portion of said tube welded to said plate, whereby said protective layer provides a barrier against water entering a gap between said tube and said plate.

10. A heat exchanger according to claim 1, wherein said tube has a plurality of bends separated by substantially straight portions, and said spot welds extend along said straight portions only.

11. A heat exchanger according to claim 1, wherein said tube has a plurality of bends separated by substantially straight portions, and said spot welds extend along said straight portions and along said bends.

12. A refrigeration unit comprising a heat exchanger according to claim 1 and a refrigeration cavity for storing items, wherein said heat exchanger is an evaporator located within said refrigeration cavity.

13. A refrigeration unit comprising a heat exchanger according to claim 1, wherein said heat exchanger is a condenser mounted on the outside of the refrigeration unit.

14. A method of manufacturing a heat exchanger for a refrigeration unit, comprising the steps of:
obtaining a metal plate having a first face and a second face; and
attaching a metal tube for containing refrigerant to said first face of said metal plate by a plurality of spot welds,
wherein said spot welds are made by a laser and said welds extend through only a portion of the thickness of said plate.

15. A refrigeration unit having a heat exchanger, said heat exchanger comprising:
a metal plate having a first face and a second face; and
a metal tube for containing refrigerant attached to said first face of said metal plate by a plurality of laser spot welds.

16. A refrigeration unit according to claim 15, wherein at least a portion of the length of said tube has a substantially flat face positioned against said first face of said plate.

17. A refrigeration unit according to claim 16, wherein said tube has a second substantially flat face parallel to the substantially flat face positioned against the plate.

18. A refrigeration unit according to claim 15, wherein at least a portion of the length of said tube has a substantially flat face positioned against said first face of said plate to provide a tube/plate interface and said spot welds are spaced along said tube on either side of said interface.

19. A refrigeration unit according to claim 15, wherein said tube and said plate comprise of aluminium or aluminium alloy.

20. A refrigeration unit according to claim 15, wherein said refrigeration unit comprises a refrigeration cavity for storing items and said heat exchanger is configured as an evaporator for cooling said refrigeration cavity.
